(19) United States
(12) Patent Application Publication
(10) Pub. No.: US 2011/0035945 A1
(43) Pub. Date: Feb. 17, 2011

(54) SPOON WITH BAG CLIP

(75) Inventor: TUNG CHOU, TAIPEI (TW)

Correspondence Address: ROSENBERG, KLEIN & LEE, 3458 ELLICOTT CENTER DRIVE-SUITE 101, ELLICOTT CITY, MD, 21043, US

(73) Assignee: AURORAL INTERNATIONAL CORPORATION, TAIPEI (TW)

(21) Appl. No.: 12/781,151

(22) Filed: May 17, 2010

(30) Foreign Application Priority Data
Aug. 14, 2009 (TW) 98214985

(51) Int. Cl. B26B 11/00

(52) U.S. Cl. 30/123

(57) ABSTRACT

A spoon with a bag clip is provided. The spoon has a handle that is provided with the clip, wherein the clip includes a clip arm provided to the handle of the spoon so that the clip arm and the handle jointly define a clip mouth, and the clip arm has a toothed surface. Thereby the spoon can be used to seal a bag and can act as a dining utensil, thus providing improved convenience.

### BACKGROUND OF THE INVENTION

1. Technical Field

The present invention relates to a spoon with a bag clip, which serves to clip and seal external food packages or bags.

2. Description of Related Art

There have been various food products sold in aluminum-foil bags on the market, including coffee powder, coffee mate, sugar, tea and so on.

Taking coffee powder products for example, the commercially available products may be divided into three sorts, namely three-in-one instant coffee sachets, caned pure coffee powder, and bagged pure coffee powder.

Therein, a bag of pure coffee powder, for post-opening storage, needs to have the aluminum-foil packing bag rolled up from the opening and pressed to expel internal air out in order to minimize contact between the coffee powder and air and to prevent the coffee powder from getting moisturized. Then the bag has to be sealed by a clip or a rubber band to secure the freshness of the coffee powder in the bag.

Although the clip or rubber band exactly seals the opening of the bag from unintentionally opening, every time when it is desired to allow a spoon to access the coffee powder in the bag, the clip or rubber band has to be removed and placed aside. Afterward, when the bag is rolled up to expel internal air and to be sealed by the clip or rubber band for storing, the clip or rubber band may sometime be lost or the rubber band may be broken due to elastic fatigue, causing inconvenience.

In view of the foregoing inconvenience and defects to be improved, the inventor of the present invention implemented his years of experience to conduct research and make improvement, and, after repeated experiments, finally invented a spoon with a bag clip that incorporates double functionality into a single structure.

### BRIEF SUMMARY OF THE INVENTION

The present invention provides a spoon with a bag clip. The spoon has a handle that is provided with the clip, wherein the clip includes a clip arm provided to the handle of the spoon so that the clip arm and the handle jointly define a clip mouth, and the clip arm has a toothed surface. Thereby the spoon can be used to seal a bag and can act as a dining utensil, thus providing improved convenience.

### BRIEF DESCRIPTION OF THE DRAWINGS

The present invention as well as a preferred mode of use and advantages thereof will be best understood by referring to the following detailed description of an illustrative embodiment in conjunction with the accompanying drawings, wherein:

FIG. 1 is a perspective view of a spoon with a bag clip according to the present invention;

FIG. 2 is another perspective view of the spoon with a bag clip according to the present invention; and

FIG. 3 is an applied view of the spoon with a bag clip showing that the spoon seals a packing bag.

### DETAILED DESCRIPTION OF THE INVENTION

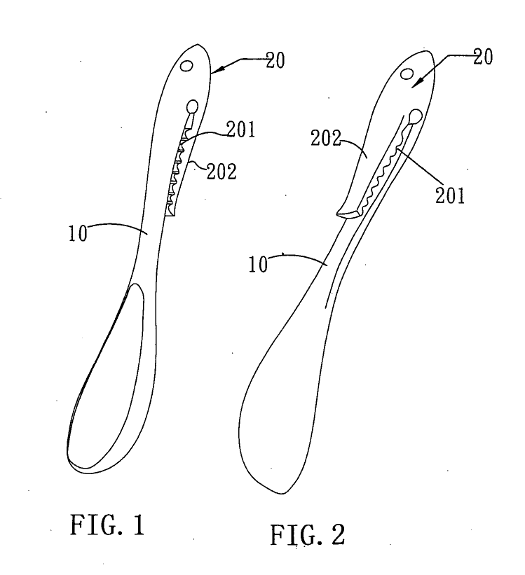

FIG. 1 is a perspective view of a spoon with a bag clip according to the present invention. As shown in FIG. 1 (also referring to FIG. 2), the spoon has a handle 10 that is provided with the clip 20. The clip 20 primarily comprises a clip arm 202 attached to the handle 10 of the spoon, so a clip mouth 201 is defined between the clip arm 202 and the handle 10. The clip arm 202 has a toothed surface.

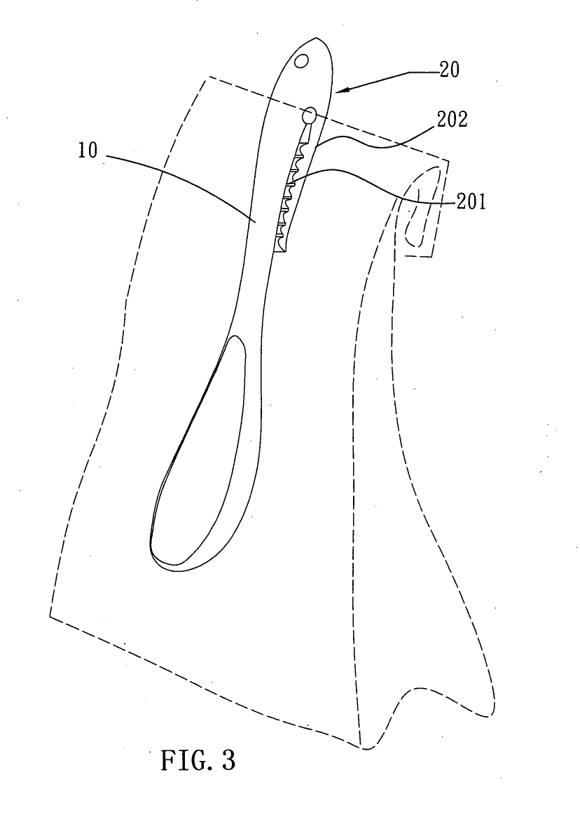

FIG. 3 shows the spoon of the present invention clipping a packing bag. After the packing bag is opened for the spoon of the present invention to take out a fill contained therein, the packing bag can be rolled or folded to expel internal air, and then the clip mouth 201 of the clip 20 on the handle 10 of the spoon of the present invention is aligned with the rolled or folded bag. Afterward, the rolled or folded bag is inserted into the clip mouth 201 of the clip 20, so the clip arm 202 and the handle 10 jointly clip and seal the bag. Therein, the toothed surface of the clip arm 202 facilitates positioning the clip with enhanced firmness.

To sum up, the present invention incorporates double functionality into a single structure for improving convenience in use and for providing the function of reliably clipping and sealing packing bags. The invention has never been seen in public use and meets the requests of utility and novelty so is herein applying for patent rights.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

1. A spoon with a bag clip, being characterized in that the spoon has a handle that is provided with the clip, wherein the clip includes a clip arm attached to the handle of the spoon so that the clip arm and the handle jointly define a clip mouth, and the clip arm has a toothed surface.
